(19) United States
(12) Patent Application Publication
(10) Pub. No.: US 2019/0061543 A1
(43) Pub. Date: Feb. 28, 2019

(54) MOTOR VEHICLE ELECTRICAL CONNECTION DEVICE COOLED BY A REFRIGERANT FLUID CIRCUIT

(71) Applicant: Valeo Systemes Thermiques, Le Mesnil Saint Denis (FR)

(72) Inventors: Bastien Jovet, Le Mesnil Saint Denis (FR); Carlos Martins, Le Mesnil Saint Denis (FR); Francois Charbonnelle, Le Mesnil Saint Denis (FR); Maël Briend, Le Mesnil Saint Denis (FR); Philippe Jouanny, Le Mesnil Saint Denis (FR); Samer Saab, Le Mesnil Saint Denis (FR); Eric Droulez, Le Mesnil Saint Denis (FR)

(73) Assignee: Valeo Systemes Thermiques, Le Mesnil Saint Denis (FR)

(21) Appl. No.: 16/108,814

(22) Filed: Aug. 22, 2018

(30) Foreign Application Priority Data
Aug. 29, 2017 (FR) 1757950

(51) Int. Cl. B60L 11/18; H01B 7/42

(52) U.S. Cl. CPC B60L 11/1825; B60L 11/1874; B60L 2230/12; B60L 2240/36; B60L 2230/14; H01B 7/423

(57) ABSTRACT

Vehicle (2) refrigerant fluid (700) circuit (1001, 1002, 1003, 1004) comprising:
a compressor (200) intended to raise the pressure of the refrigerant fluid (700),
a condenser (300, 301), located downstream of the compressor (200) according to a circulating direction of the refrigerant fluid (700) in the circuit (1001, 1002, 1003, 1004),
an expansion member (401, 402, 403, 404, 405), located downstream of the condenser (300, 301), which is intended to lower the pressure of the refrigerant fluid (700),
an evaporator (600, 601), located downstream of the expansion member (401, 402, 403, 404, 405),
   characterized in that it comprises a heat exchanger (900) dedicated to cooling a charge port (12) located on the vehicle and/or the interconnect located on the vehicle (2) linking an electrical source and the battery (3) to be charged.

The present invention relates to the field of charging motor vehicle batteries, and particularly traction batteries for hybrid or electric motor vehicles. Traction batteries mean any energy storage device making it possible to generate a motive force for the motor vehicle. The subject matter of the invention is the heat exchanger intended to cool the electrical connection device, located on the vehicle, allowing the charging of such batteries, as well as the associated cooling circuit.

A traction battery can be charged via electrical connection. A first manner of charging the battery, called rapid charging, is used by dedicated stations, which are configured to deliver direct current, for example. For this purpose, a charging cord linked to the station is equipped with a pistol-type plug to be connected to the charge port of the vehicle. For example, by delivering a direct current of 120 amps, this type of station makes it possible to completely charge the traction battery in 20 to 30 minutes. Generally, such a rapid charging station is arranged to deliver 350 kilowatts.

A second manner of charging the battery, called normal charging, is used by a connection to a home electrical network port. For this purpose, a charging cord comprising, at the first end thereof, a mains supply plug and, at the second end thereof, a pistol-type plug, is intended to be connected to the charge port of the vehicle. The charging cord also comprises a transformation box located between the two ends. This type of charging generally requires 8 to 12 hours of connection in order to completely charge the traction battery.

A third manner of charging the battery, called regeneration, is implemented during the braking and deceleration phases. Indeed, during a braking or deceleration phase, the wheels of the motor vehicle drive the electric motor of the motor vehicle in a rotation direction allowing a, so-called regeneration, electric current to be produced, which is used for charging the traction battery. This manner of charging the traction battery only uses one of the three phases of the motor, and the charging output is therefore quite weak.

A well-known disadvantage of charging, regardless of whether it is of the rapid charging or normal charging type, is that the connection between the electrical source and the vehicle battery to be charged releases a substantial thermal power. Yet, the heating of these elements results in a reduction of the electrical power transmitted to the battery, particularly when a threshold temperature is reached. Thus, when the heating reaches this threshold temperature, the charging duration of the battery is prolonged with respect to the theoretical values based exclusively on the transfer of the electrical power. Yet, given the market requirements, this prolonging of the charging duration represents a disadvantage to be overcome, particularly in the case of rapid charging.

For this purpose, the prior art proposes solutions for cooling the charging station and/or the charging cord. For example, the document EP0823767 proposes providing a charging cord comprising a cooling fluid canal fed with cooling fluid coming from the charging station.

However, the prior art does not appear to propose a solution that aims to cool the charge port located on the vehicle and/or the interconnect linking the charge port located on the vehicle and the battery to be charged.

In this context, the subject matter of the present invention is a vehicle refrigerant fluid circuit comprising:
a compressor (200) intended to raise the pressure of the refrigerant fluid (700),
a condenser (300, 301), located downstream of the compressor (200) according to a circulating direction of the refrigerant fluid (700) in the circuit (1001, 1002, 1003, 1004),
an expansion member (401, 402, 403, 404, 405), located downstream of the condenser (300, 301), which is intended to lower the pressure of the refrigerant fluid (700),
an evaporator (600, 601), located downstream of the expansion member (401, 402, 403, 404, 405),
   characterized in that it comprises a heat exchanger (900) dedicated to cooling a charge port (12) located on the vehicle and/or the interconnect located on the vehicle (2) linking an electrical source and the battery (3) to be charged.

Such a circuit firstly makes it possible to heat and/or air condition a motor vehicle interior and secondly to cool the connection device using the heat exchanger which is dedicated thereto. This circuit is particularly advantageous, in that the heat exchanger dedicated to cooling a charge port located on the vehicle and/or the interconnect located on the vehicle linking an electrical source and the battery to be charged can be directly incorporated on a refrigerant fluid circuit which already exists on the vehicle.

The heat exchanger dedicated to cooling the electrical connection device makes it possible to cool the connection between an electrical source and the vehicle battery to be charged. More precisely, this cooling makes it possible to remain below the threshold temperature, thus preventing damage to components of the connection device that surround the electrical conductors. In short, the invention improves the transfer of electrical power toward the battery and, consequently, reduces the charging time.

The invention thus provides a solution meeting the market requirements by proposing a heat exchanger intended to cool, for example, the charge port located on the vehicle and/or the interconnect located on the vehicle linking an electrical source and the battery to be charged.

According to one or more characteristics of the invention which can be taken individually or in combination, it is possible to envisage that:
the heat exchanger dedicated to cooling the electrical connection device is configured to produce a heat exchange between the refrigerant fluid and the electrical connection device. It is then understood that the heat exchanger dedicated to cooling the electrical connection device allows an exchange of calories between the electrical connection device and the refrigerant fluid. For this purpose, the heat exchanger dedicated to cooling the electrical connection device interacts firstly with components of the electrical connection device and secondly with the refrigerant fluid by allowing this fluid to circulate. More precisely, the heat exchanger dedicated to cooling the electrical connection device comprises at least one duct in which the refrigerant fluid circulates.

It should be noted that a refrigerant fluid is defined as a fluid allowing calorie exchanges during the changes in phases (liquid, vapour, gas, etc.) thereof. In other words, a refrigerant fluid is a fluid which has physical particular features making it possible to utilize it in a compression/expansion cycle in order to transfer calories.

More particularly, the refrigerant fluids are chosen for the temperatures thereof for transition from the liquid state to the gas state, the quantity of energy necessary to cause this change of state and the difference in temperature caused by this change of state.

By way of example, such a refrigerant fluid is known by the acronym R-134A, 1234YF or R744.
The heat exchanger is intended to be located as closely as possible to the electrical connection device. The term “as closely as possible” means that the heat exchanger dedicated to cooling the electrical connection device is located at a sufficiently close distance, or in contact, in order to produce the heat exchange with the electrical connection device.
The connection device comprises at least one electrical conductor for providing an electrical link toward the battery.
The connection device comprises a charge port having at least one electrical terminal in electrical contact with the at least one electrical conductor.
The connection device comprises a charging cable extending from the charge port and as far as the battery and comprising the at least one electrical conductor.
The battery is a traction battery.
The heat exchanger dedicated to cooling the electrical connection device is placed between the condenser and the compressor of the circuit.
The circuit comprises a cooling branch which includes the heat exchanger dedicated to cooling the electrical connection device, said cooling branch extending into a low-pressure segment connected to the condenser and to the compressor. Thus, at the exit of the condenser, it is ensured that the refrigerant fluid is at low temperature, which allows the transfer of calories. The cooling branch is thus placed on the low-pressure side of the refrigerant fluid circuit.
The cooling branch extends parallel to an air conditioning branch including the evaporator, from a first intersection formed between the air conditioning branch and the exit branch of the condenser and a second intersection formed by the air conditioning branch and the inlet branch of the compressor.
The cooling branch comprises a flow rate control valve located between the condenser and the heat exchanger dedicated to cooling the electrical connection device. Such a flow rate control valve makes it possible to control the circulation of the refrigerant fluid in the cooling branch.
The cooling branch extends parallel to a so-called air conditioning branch comprising the evaporator. Thus, the cooling branch can be fed with refrigerant fluid independently of the air conditioning branch and vice versa. It can also be envisaged to feed the two branches simultaneously. In this case, an element regulating the flow rates in these branches can be provided.
The cooling branch comprises an expansion member, called a second expansion member, located between the condenser and the heat exchanger dedicated to cooling the electrical connection device. In other words, the second expansion member is located downstream of the condenser and upstream of the heat exchanger dedicated to cooling the electrical connection device, according to a circulating direction of the refrigerant fluid in the cooling branch. Such an expansion member makes it possible to lower the pressure of the refrigerant fluid, resulting in lowering the temperature thereof. Thus, the refrigerant fluid circulating in the heat exchanger dedicated to cooling the electrical connection device is at low temperature, this heat exchanger dedicated to cooling the electrical connection device then behaving like an evaporator for the refrigerant fluid.
The flow rate control valve is, for example, located upstream of the second expansion member, according to a circulating direction of the refrigerant fluid in the cooling branch.
The circuit comprises a second heat exchanger intended for cooling a traction battery of the vehicle. Thus, the circuit makes it possible to firstly cool the traction battery and secondly the electrical connection device.
The circuit comprises a thermal treatment branch including the second heat exchanger, said thermal treatment branch being placed parallel to the cooling branch. In other words, the heat exchanger dedicated to cooling the electrical connection device and the second heat exchanger are placed in parallel. This embodiment of the circuit makes it possible to selectively feed the first heat exchanger or the second heat exchanger, particularly when at least one flow rate control valve is provided.
The circuit comprises a thermal treatment branch including the second heat exchanger, the cooling branch forming a bypass for said thermal treatment branch. Such a bypass has the advantage of being able to be fitted on already existing circuits. Thus, the manufacture of such a circuit is facilitated thereby.
The thermal treatment branch comprises a flow rate control valve located between the condenser and the second heat exchanger.
The thermal treatment branch comprises an expansion member located between the condenser and the second heat exchanger.
The heat exchanger dedicated to cooling the connection device is placed in series with the second heat exchanger on the cooling branch. It is then understood that the connection device is unavoidably cooled during the cooling of the battery and vice versa.
According to an example, the heat exchanger dedicated to cooling the connection device is placed downstream of the second heat exchanger, according to a circulating direction of the refrigerant fluid in the cooling branch. Thus, the refrigerant fluid firstly cools the battery and then the connection device.

This embodiment has the advantage of using a same flow rate control valve and/or a same expansion member for cooling the battery and the connection device.

Another advantage of this embodiment is the optimization of the lifetime of the compressor. Indeed, during charging of the battery, the average temperature of the electrical connection device is clearly greater than the average temperature of the battery. Consequently, positioning the cooling of the electrical connection device downstream of the cooling of the battery makes it possible to overheat the refrigerant fluid and therefore to maximize the gas portion of the refrigerant fluid which is moving toward the compressor. Moreover, this makes it possible to improve the efficiency of the second heat exchanger by ensuring that the refrigerant fluid circulating therein is exclusively or almost exclusively in liquid form.
The circuit is intended to cooperate with a ventilating, heating and/or air conditioning system in which the condenser and/or the evaporator is placed.
The circuit comprises an air heater that can be used as an evaporator or condenser. Preferably, this air heater is intended to be placed at the front side of the vehicle.

Other characteristics, details and advantages of the invention and of the operation thereof will emerge more clearly upon reading the description given hereafter by way of illustration, with reference to the appended figures, wherein:

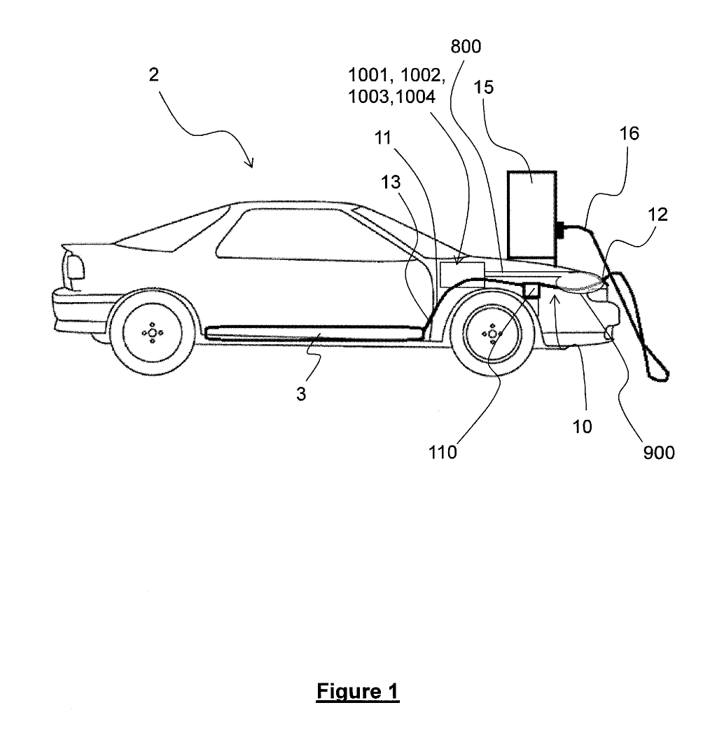

FIG. 1 is a schematic representation of a motor vehicle comprising an electrical connection device according to the present invention for charging a battery, the motor vehicle being linked to an outer electrical source,

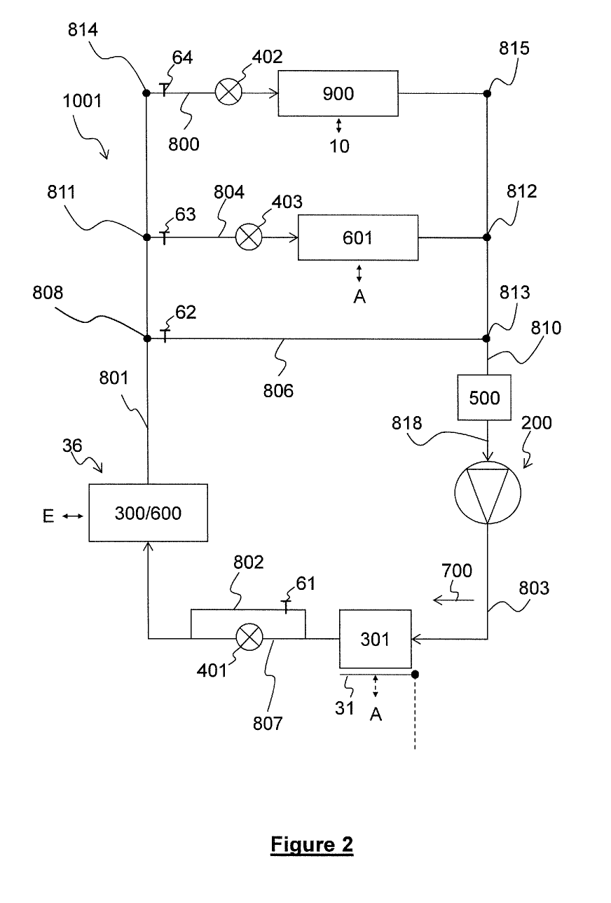

FIG. 2 is a schematic representation of a first example of a refrigerant fluid circuit, according to the present invention, equipped with a cooling branch comprising a heat exchanger dedicated to cooling the electrical connection device with which the motor vehicle is equipped,

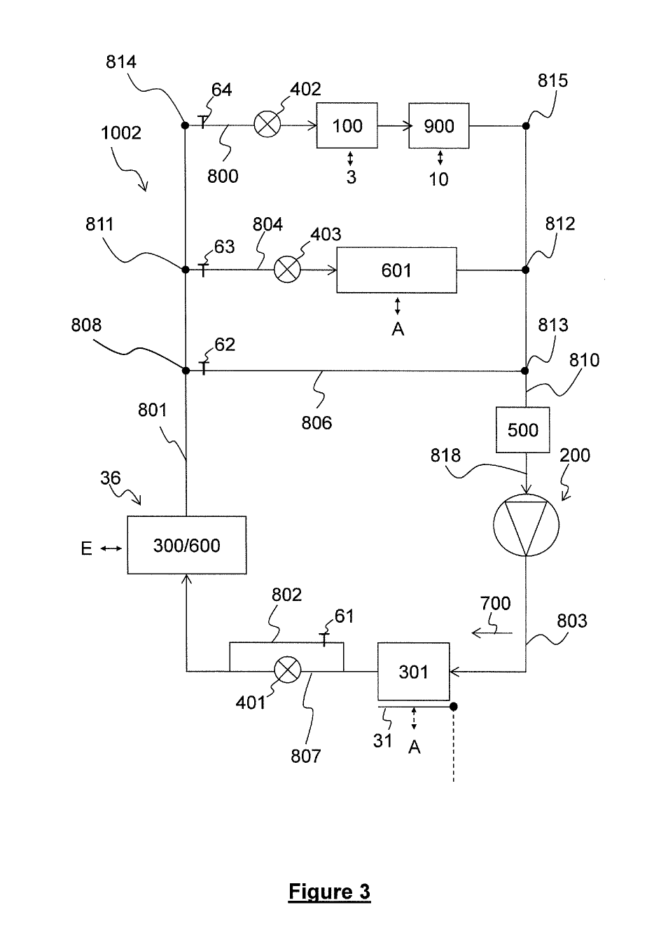

FIG. 3 is a schematic representation of a second example of a refrigerant fluid circuit, according to the present invention,

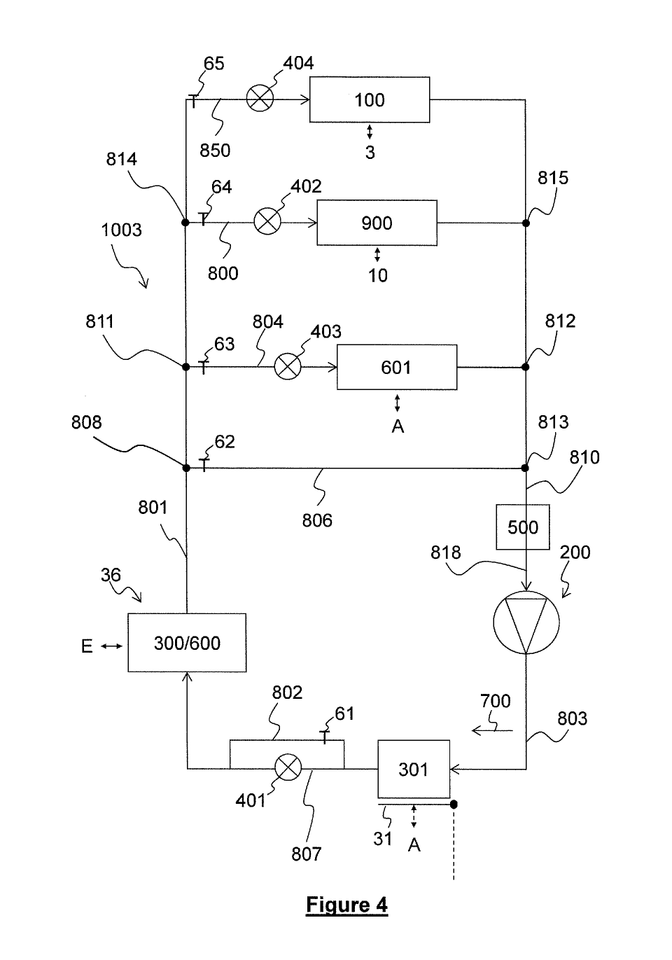

FIG. 4 is a schematic representation of a third example of a refrigerant fluid circuit, according to the present invention,

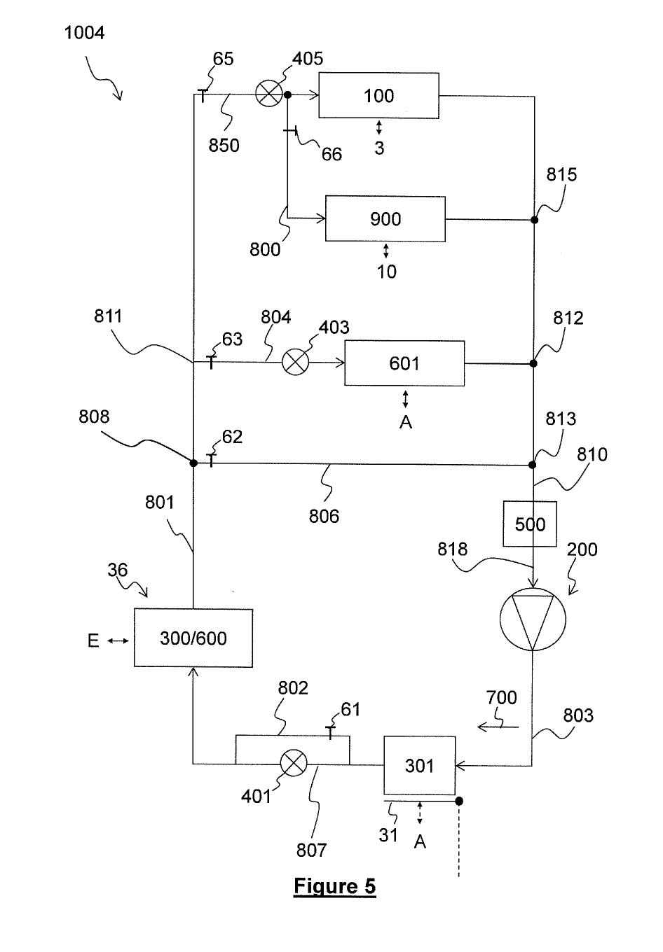

FIG. 5 is a schematic representation of a fourth example of a refrigerant fluid circuit, according to the present invention.

It should firstly be noted that, if the figures disclose the invention in detailed manner for the application thereof, they can of course be used to better define the invention when required. Likewise, it is stated that, for all of the figures, the same elements are designated by the same references numbers.

FIG. 1 shows a motor vehicle 2, for example of full electric or hybrid type, connected to an electrical source 15, in order to recharge a battery. According to this example, the electrical source 15 makes it possible to recharge a traction battery 3 of the motor vehicle 2. Traction batteries mean any energy storage device making it possible to generate a motive force of the motor vehicle. In order to transfer the electricity provided by the electrical source 15 toward the motor vehicle 2, and particularly toward the traction battery 3, the motor vehicle comprises an electrical connection device 10.

The electrical source 15 is, in this case, a rapid charging station substantially delivering 350 kilowatts (kW). Of course, the electrical source 15 could also be a home electrical network port allowing normal charging of the traction battery 3 or a system for regenerating energy during the braking or the deceleration of the vehicle.

More precisely, the electrical connection device 10 is integral with the motor vehicle 2. This means that the electrical connection device 10 is located on the vehicle 2, i.e. that, even under driving conditions, the electrical connection device 10 is part of the vehicle 2.

The electrical connection device 10 comprises a charge port 12 located on an accessible part of the vehicle 2, and to which a user can join a charging cord 16 electrically connected to the electrical source 15. The charge port 12 makes it possible to link the traction battery 3 of the vehicle to be charged to the charging cord 16, electrically connected to the electrical source 15, the charging cord 16 not being part of the electrical connection device 10.

In order to charge the traction battery 3, the charge port 12 is electrically linked to the traction battery 3. For this purpose, the electrical connection device 10 comprises at least one charging cable 13 extending between the traction battery 3 and the charge port 12. It should be noted that, to provide an electrical link between these various elements, the electrical connection device 10 comprises at least one electrical conductor 11 extending between the charge port 12 and the traction battery 3. The electrical conductor 11 is present in the charge port 12, as electrical terminals, then continues by taking the form of the charging cable 13, as far as the traction battery 3. Such an electrical conductor 11 makes it possible to transfer the electrical energy toward the traction battery 3. More precisely, the electrical conductor 11 comprises a first part intended to be linked to the positive connector of the electrical source 15, via one of the electrical terminals, and a second part intended to be linked to the negative connector of the electrical source 15, via another one of the electrical terminals.

Moreover, it can be envisaged that the electrical connection device 10 comprises a transformation box 110 for treating the electrical current which is directed toward the traction battery 3.

In order to cool the electrical connection device 10 during the charging of the traction battery 3, the electrical connection device 10 can be equipped with a heat exchanger intended to cooperate with a cooling source coming from the motor vehicle 2. More precisely, according to the present invention, the cooling source corresponds to a refrigerant fluid circuit 1001, 1002, 1003, 1004 which collaborates with a ventilating, heating, and/or air conditioning system for an interior of the motor vehicle 2.

For this purpose, and as will be described later, the circuit 1001, 1002, 1003, 1004 comprises a cooling branch 800 intended to be fed with refrigerant fluid 700. More precisely, this cooling branch 800, intended to be crossed by a refrigerant fluid 700, comprises a heat exchanger 900 dedicated to cooling the electrical connection device 10. It is then understood that the heat exchanger 900 dedicated to cooling the electrical connection device 10 forms an interface between the electrical connection device 10 and the refrigerant fluid circuit. Preferably, the heat exchanger 900 dedicated to cooling the electrical connection device 10 is in the form of a thermally conductive tube, in which the refrigerant fluid 700 is intended to circulate at low temperature.

More particularly, the heat exchanger 900 dedicated to cooling the electrical connection device 10 is dedicated to the partial or complete cooling of the electrical connection device 10. To this end, the heat exchanger 900 dedicated to cooling the electrical connection device 10 can have various forms.

According to a first example and in order to cool the charge port 12 of the electrical connection device 10, the thermally conductive tube extends around, inside or along the charge port 12 only. Preferably, the thermally conductive tube extends as closely as possible to the electrical terminals of the charge port 12. As closely as possible means in a sufficiently close manner such that there is heat exchange between the heat exchanger 900 dedicated to cooling the electrical connection device 10 and the electrical terminals.

It is understood that the thermally conductive tube is integral with the electrical connection device 10, particularly by means of the heat exchanger 900 dedicated to cooling the electrical connection device 10. In this case, the electrically conductive tube is indeed intended to cooperate with the refrigerant fluid 700 circuit 1001, 1002, 1003, 1004.

According to a second example and in order to cool the charging cable 13 of the electrical connection device 10, the thermally conductive tube extends along, around or inside the charging cable 13, exclusively and as closely as possible thereto. As closely as possible means in a sufficiently close manner such that there is heat exchange between the heat exchanger 900 dedicated to cooling the electrical connection device 10 and the electrical terminals.

According to a third example, wherein the entirety of the electrical connection device 10 is cooled, the thermally conductive tube extends along, around, and/or inside the charging cable 13, around, inside and/or along the charge port 12. It can also be envisaged to cool the transformation box 110.

Several examples of the refrigerant fluid 700 circuit will now be described with reference to FIGS. 2 to 5. However, it should be noted that, for all of these examples, each of the circuits 1001, 1002, 1003, 1004 comprises a compressor 200, at least one condenser 300, 301, at least one expansion member 401, 402, 403, at least one internal evaporator 601 and a heat exchanger 900 dedicated to cooling the electrical connection device 10. The refrigerant fluid 700 circulates successively through these elements by forming a closed circuit. Moreover, hereafter, the descriptions upstream and downstream will be used with reference to the circulating direction of the refrigerant fluid within the circuit 1001, 1002, 1003, 1004.

Thus, as can be seen in the examples shown in FIGS. 2 to 5, the compressor 200 is linked to an internal condenser 301 by a branch 803 in which the refrigerant fluid 700 circulates at high pressure, and therefore at high temperature. This internal condenser 301 is located in the ventilating, heating and/or air conditioning system and is optionally selectively crossed by an air flow A, using an obstructing device 31. It should be noted that the description “internal” refers to an element located inside the ventilating, heating and/or air conditioning system.

When the internal condenser 301 is crossed by the air flow A, the refrigerant fluid 700 exchanges calories with this air flow A and is in a different state when exiting this internal condenser 301. When the obstructing device 31 prevents the air flow A from crossing the internal condenser 301, the refrigerant fluid 700 does not exchange calories and does not change state when crossing the internal condenser 301.

Upon exiting this internal condenser 301 and depending on the state of the refrigerant fluid 700, the refrigerant fluid crosses a branch 802 on which a flow rate control valve 61, called a first valve 61, is located or a branch 807 on which an expansion member, called a first expansion member 401, is placed.

Upon exiting these two branches 802, 807, the refrigerant fluid 700 is directed toward an air heater 36 that can be used as a condenser 300 or an evaporator 600, depending on the state of the refrigerant fluid 700. This air heater 36 is located at the front side of the motor vehicle 2, such as to be exposed to an outer air flow E. Upon exiting this air heater 36, the refrigerant fluid 700 takes a branch 801 as far as a junction 808.

When leaving this junction 808, the refrigerant fluid 700 is intended to take one or more branches placed in parallel before again reaching the compressor 200. Among these branches placed in parallel can be seen a first branch 806, called a return branch 806, on which only a flow rate control valve, called a second flow rate control valve 62, is placed, and a second branch 804, called an air conditioning branch, on which at least one internal evaporator 601 is provided.

The internal evaporator 601 is located in the ventilating, heating and/or air conditioning system and is exposed to an air flow A. The air conditioning branch 804 forms a first intersection 811 with the branch 801 leaving the air heater 36 and a second intersection 812 with a branch 810 leading toward an accumulator 500.

It should be specified that the return branch 806 originates at the junction 808 and forms an intersection, called a third intersection 813, with a branch 810 leading toward an accumulator 500.

According to some of the circuit examples which will be described below, among these branches placed in parallel can also be seen a cooling branch 800 on which at least one heat exchanger 900 dedicated to cooling the electrical connection device 10 is provided. It should be specified that the cooling branch 800 forms an intersection, called a fourth intersection 814, with the branch 801 leaving the air heater 36 and another intersection, called a fifth intersection 815, with the branch 810 leading toward the accumulator 500.

According to other circuit examples shown in FIGS. 4 to 5, among these branches placed in parallel can also be seen a branch 850, called an additional branch, dedicated to cooling the traction battery 3, on which at least one heat exchanger 100 dedicated to cooling the traction battery 3 is provided.

Upon exiting these various branches 800, 804, 806, 850, the refrigerant fluid 700 is transported in a branch 810 leading toward an accumulator 500. This accumulator 500 makes it possible to ensure that only the gas phase of the refrigerant fluid 700 moves toward the compressor 200, via a branch 818 linking the accumulator 500 to the compressor 200. It should be noted that the refrigerant fluid 700 circulating in the branch 810 ending the circuit is at low pressure. The branch 810 and the branch 818, located downstream of the branch 810 and upstream of the compressor 200, can be referred to by the term “low-pressure branch” of the circuit.

It should be noted that for all of the circuits 1001, 1002, 1003, 1004 that will be described, the refrigerant fluid 700, upon exiting the heat exchanger 900 dedicated to cooling the electrical connection device 10, is always directed toward the compressor 200. For this purpose, the cooling branch 800 of the electrical connection device 10 extends from the air heater 36 and as far as the compressor 200. More precisely, the cooling branch 800 extends parallel to the branch 804 including the internal evaporator 601, from the first intersection 811 toward the second intersection 812.

In all cases of circuits 1001, 1002, 1003, 1004 which will be described, the refrigerant fluid 700 is admitted in essentially gas form inside the compressor 200. Upon exiting the compressor 200, the refrigerant fluid 700, which has been compressed, is in the form of a gas having an increased pressure and temperature.

FIG. 2 schematically shows a first example of a refrigerant fluid 700 circuit 1001, which collaborates with a ventilating, heating, and/or air conditioning system for a motor vehicle interior.

According to a first so-called air conditioning operating mode, the refrigerant fluid 700, upon exiting the compressor 200, is admitted into an air heater 36 which can equally be used as a condenser 300 or as an evaporator 600, depending on the state in which the refrigerant fluid 700 circulates within this air heater 36. The refrigerant fluid 700 being in this example in gas form, this air heater 36 behaves like a condenser 300, in which it undergoes a first phase change and transforms into liquid. During this phase change, the pressure of the refrigerant fluid 700 remains constant and the temperature thereof reduces, the refrigerant fluid 700 yielding some of the heat thereof to an outer air flow E by means of the condenser 300.

It should be noted that the circuit 1001 comprises an internal condenser 301, which in this air conditioning operating mode, is not used. Indeed, it can be seen that the obstructing device 31, such as a flap, is in the closed position such as to prevent any exchange with an air flow A crossing the ventilating, heating, and/or air conditioning system. Consequently, the refrigerant fluid 700 crosses this internal condenser 301 without undergoing transformation. Moreover, the first expansion member 401 located on the branch 807, at the outlet of this internal condenser 301 is not used in this air conditioning operating mode and the refrigerant fluid 700 takes the branch 802 in order to reach the air heater 36 operating as a condenser 300.

According to a first example of use, part of the refrigerant fluid 700 is transported toward the branch 804 supporting the internal evaporator 601 and another part is transported toward the cooling branch 800. The refrigerant fluid 700, essentially in liquid form at the outlet of the condenser 300, is then transported toward an expansion member 402, called a second expansion member 402, located on the cooling branch 800 and an expansion member 403, called a third expansion member 403, located on the air conditioning branch 804 supporting the internal evaporator 601. The expansion used by the expansion members 401, 402, 403 makes it possible to lower the pressure of the refrigerant fluid 700, the result of which is obtaining a refrigerant fluid 700 in the liquid state and at low temperature.

The placement of the expansion members 402, 403 on each of the branches 800, 804, i.e. with the second expansion member 402 located on the cooling branch 800 and the third expansion member 403 located on the air conditioning branch 804, makes it possible to avoid heat exchange losses by reducing the distance covered by the refrigerant fluid 700 at low temperature before reaching the internal evaporator 601 or the heat exchanger 900 dedicated to cooling the electrical connection device 10. Alternatively, it is possible to provide a single expansion member located on a segment of the branch 801, at the outlet of the air heater 36 and upstream of the junction 808 distributing the refrigerant fluid toward the already described various parallel branches 800, 804, 806 of the circuit 1001.

It is notable that, according to the air conditioning operating mode, the return branch 806 is not used, and thus the second flow rate control valve 62 located on this return branch 806 is in the closed position such as to prevent any passage of refrigerant fluid 700, in liquid form, toward the compressor 200.

The part of the refrigerant fluid 700 transported toward the internal evaporator 601 exchanges calories with an air flow A crossing the internal evaporator 601. This air flow A, circulating in the ventilating, heating and/or air conditioning system, is cooled and sent toward the vehicle interior.

The part of the refrigerant fluid 700 transported toward the cooling branch 800 is transported toward the heat exchanger 900 dedicated to cooling the electrical connection device 10 described above and exchanges calories with part of the electrical connection device 10 or the entire electrical connection device 10, depending on the form that the heat exchanger 900 dedicated to cooling the electrical connection device 10 takes.

It is understood from this first example of use that the interior of the motor vehicle 2 is air conditioned during the cooling of the electrical connection device 10. Thus, during charging of the traction battery 3 by a fixed electrical source 15, such an example of use also allows preconditioning of the interior of the motor vehicle 2, i.e. before the user uses it. It should be noted that the electrical consumption due to the operation of such a refrigerant fluid 700 circuit 1001 is negligible compared to the gain in power allowed by the cooling of the electrical connection device 10.

According to a second example of use, a flow rate control valve, called a third flow rate control valve 63, is placed on the air conditioning branch 804, upstream of the internal evaporator 601 according to the circulating direction of the refrigerant fluid 700 in the air conditioning branch 804. When this third flow rate control valve 63 is in the closed position, it makes it possible to transport the entire refrigerant fluid 700 toward the cooling branch 800. Thus, the entire refrigerant fluid 700 is used to exchange calories with part of or the entire electrical connection device 10, depending on the form that the heat exchanger 900 dedicated to cooling the electrical connection device 10 takes.

It should be noted that the third flow rate control valve 63 is located upstream of the third expansion member 403 located on the air conditioning branch 804, upstream being understood according to the circulating direction of the refrigerant fluid 700 in the air conditioning branch 804. However, whether the third flow rate control valve 63 is located upstream or downstream of the third expansion member 403, it should be noted that the third flow rate control valve makes it possible to avoid the expansion of the refrigerant fluid 700 when it is in a position preventing the refrigerant fluid 700 from circulating in the air conditioning branch 804.

Thus, this second example of use makes it possible to not air condition the interior of the motor vehicle 2 when cooling the electrical connection device 10, which makes it possible to dedicate the calorific power of the circuit 1001 to cooling the electrical connection device 10.

Moreover, it is notable that the cooling branch 800 is also equipped with a flow rate control valve, called a fourth flow rate control valve 64 making it possible to deactivate the cooling of the electrical connection device 10. Indeed, when the motor vehicle 2 is driven, or during a start-up phase, it is not necessary to cool the electrical connection device 10.

It should be noted that the fourth flow rate control valve 64 is located upstream of the second expansion member 402 located on the cooling branch 800, according to the circulating direction of the refrigerant fluid 700 in the air conditioning branch 800. In the same manner as above, whether the fourth flow rate control valve 64 is located upstream or downstream of the second expansion member 402, it should be noted that the fourth flow rate control valve makes it possible to avoid the expansion of the refrigerant fluid 700 when it is in a position preventing the refrigerant fluid 700 from circulating in the cooling branch 800.

During the calories exchanges, whether in the internal evaporator 601 or in the heat exchanger 900 dedicated to cooling the electrical connection device 10, the refrigerant fluid 700 undergoes a new phase change by transforming into gas. It is then transported again toward the compressor 200 in order to undergo a new cycle.

To ensure that the compressor 200 compresses refrigerant fluid 700 in exclusively gas form, the circuit 1001 is advantageously equipped with an accumulator 500 located directly upstream of the compressor 200. In other words, an accumulator 500 can be provided on the circuit 1001 between the internal evaporator 601 and the compressor 200 or between the heat exchanger 900 dedicated to cooling the electrical connection device 10 and the compressor 200, such that the compressor 200 only compresses refrigerant fluid 700 in exclusively gas form.

According to a so-called heat pump second operating mode, the refrigerant fluid 700 in gas form at high pressure and high temperature, upon exiting the compressor 200, is admitted into the internal condenser 301, which is active according to this operating mode.

For this purpose, the obstructing device 31 is in the open position, as is shown by dotted lines in FIGS. 2 to 5, such that the internal condenser 301 is exposed to an air flow A crossing the ventilating, heating and/or air conditioning system in order to be sent in the direction of the interior of the vehicle 2. When the refrigerant fluid 700 passes along the internal condenser 301, it yields the calories thereof to the air flow A crossing the internal condenser 301, such as to provide a hot air flow A in the direction of the interior.

When the refrigerant fluid 700 passes into the internal condenser 301, it undergoes a first phase change and transforms into liquid. During this phase change, the pressure of the refrigerant fluid 700 remains constant and the temperature thereof decreases, the refrigerant fluid 700 yielding some of the heat thereof to the air flow A crossing the internal condenser 301.

The refrigerant fluid 700, essentially in liquid form when exiting the internal condenser 301, is then transported into the first expansion member 401, the passage toward the branch 802 being closed by the first flow rate control valve 61. The refrigerant fluid 700 then undergoes an expansion making it possible to lower the pressure thereof resulting in a refrigerant fluid 700 in the liquid state and at low temperature.

The refrigerant fluid 700 is then transported toward the air heater 36. The refrigerant fluid 700 in this case being in liquid form, this air heater 36 behaves like an evaporator 600, wherein the refrigerant fluid 700 exchanges the calories thereof with a medium surrounding the air heater 36 and particularly with the outer air flow E. It should be noted that the heat pump mode of the circuit 1001 is generally used when the outer medium is cold, thus the refrigerant fluid 700, despite becoming gas, remains at low temperature when exiting the air heater 36.

According to a first example of use of the heat pump mode, part of the refrigerant fluid 700, when exiting the air heater 36, is transported toward the cooling branch 800 which feeds the heat exchanger 900 dedicated to cooling the electrical connection device 10 described above and the other part of the refrigerant fluid 700 is transported directly toward the compressor 200 by passing through the return branch 806, with the second flow rate control valve 62 in the open position.

The part of the refrigerant fluid 700 passing through the cooling branch 800, in gas form and at low temperature, then exchanges calories with part of the electrical connection device 10 or with the entire electrical connection device 10, depending on the form that the heat exchanger 900 dedicated to cooling the electrical connection device 10 takes. At the end of this calorie exchange, the refrigerant fluid 700 is then transported again toward the compressor 200 for a new cycle.

According to a second example of use of the heat pump mode and in order to more efficiently cool the electrical connection device 10, the second flow rate control valve 62 located on the return branch 806 is in the closed position. Thus, the entirety of the refrigerant fluid 700, when exiting the air heater 36, is transported toward the cooling branch 800 which feeds the heat exchanger 900 dedicated to cooling the electrical connection device 10 described above.

It should be noted that the cooling branch 800 is equipped with the fourth flow rate control valve 64 making it possible to interrupt the cooling of the electrical connection device 10. Indeed, when the motor vehicle 2 is driven, or during a start-up phase, it is not necessary to cool the electrical connection device 10. In this case, the refrigerant fluid 700 when exiting the air heater 36 is directly transported toward the compressor 200 by the return branch 806, the second flow rate control valve 62 of which is in the open position.

According to this heat pump operating mode, access to the internal evaporator 601 located on the air conditioning branch 804 is disabled by positioning the third flow rate control valve 63 located on this branch 804 in the closed position. However, according to a dehumidification mode, the third flow rate control valve 63 is put into the open position such as to capture the moisture of the air flow A circulating in the ventilating, heating and/or air conditioning system before the heating thereof by the internal condenser 301. Indeed, it should be specified that, according to the direction of the air flow A circulating in the ventilating, heating and/or air conditioning system, the internal condenser 301 is placed downstream of the internal evaporator 601.

For the refrigerant fluid 700 circuit 1001 to be equally well suited to the air conditioning mode as to the heat pump mode, it is understood that the ventilating, heating and/or air conditioning system, with which the circuit 1001 cooperates, and the circuit 1001 itself, comprise two-way valves, three-way valves, circulation ducts for the refrigerant fluid 700 and one or more obstructing devices 31.

Advantageously, the refrigerant fluid 700 circuit 1002, 1003, 1004 is also arranged to cool the traction battery 3 of the motor vehicle 2. For this purpose, a heat exchanger 100 dedicated to cooling the traction battery 3, called an additional heat exchanger 100, is provided on this circuit, as will be described with reference to FIGS. 3 to 5.

Such an additional heat exchanger 100 is, firstly, arranged as closely as possible to the traction battery 3 in order to capture the calories thereof, by forming, for example, a support for the traction battery, and, secondly, configured to circulate the refrigerant fluid 700, by being supplied with circulation pipes, for example.

According to the example shown in FIG. 3, this second example of a refrigerant fluid 700 circuit 1002 is entirely identical to the circuit 1001 illustrated in FIG. 2, with the exception of the presence of the additional heat exchanger 100 dedicated to cooling the traction battery 3, which additional heat exchanger is placed on the cooling branch 800. In other words, the cooling branch 800 comprises two heat exchangers 100, 900 placed one after another on this branch 800. The additional heat exchanger 100 is installed in series with the heat exchanger 900 dedicated to cooling the electrical connection device 10.

More particularly, the additional heat exchanger 100 is located upstream of the heat exchanger 900 dedicated to cooling the electrical connection device 10, according to the circulating direction of the refrigerant fluid 700 in the cooling branch 800. Thus, whether during the charging of the battery 3 or during driving, the traction battery 3 is cooled before the electrical connection device 10 is cooled. This example has the advantage of not having to add a flow rate control valve or an expansion member for the cooling of the traction battery 3, with respect to the circuit 1001 illustrated in FIG. 2.

Another advantage of this second example of a circuit 1002 is the optimization of the lifetime of the compressor 200. Indeed, during the charging of the traction battery 3, the average temperature of the electrical connection device 10 is clearly greater than the average temperature of the traction battery 3. Consequently, positioning the cooling of the electrical connection device 10 downstream of the cooling of the traction battery 3 makes it possible to optimize the vaporization of the refrigerant fluid 700 when exiting the heat exchanger 900 dedicated to cooling the electrical connection device 10. Thus, the gas part of the refrigerant fluid 700 moving toward the compressor 200 is maximized. Moreover, this makes it possible to improve the efficiency of the additional heat exchanger 100 by ensuring that the refrigerant fluid 700 circulating therein is exclusively or almost exclusively in liquid form.

Of course, depending on the arrangement of the motor vehicle 2, it could be envisaged to place the heat exchanger 900 dedicated to cooling the electrical connection device 10 upstream of the additional heat exchanger 100 dedicated to cooling the traction battery 3, upstream being understood according to the circulating direction of the refrigerant fluid 700 in the cooling branch 800.

According to the example shown in FIG. 4, this third example of a circuit 1003 is entirely identical to the circuit 1001 illustrated by FIG. 2, with the exception of the presence of a thermal treatment branch 850 comprising an additional heat exchanger 100 dedicated to cooling the traction battery 3. In other words, the heat exchanger 900 dedicated to cooling the electrical connection device 10 is installed parallel to the additional heat exchanger 100. It will be noted that the additional heat exchanger 100 is also installed parallel to the internal evaporator 601.

The thermal treatment branch 850 is placed between the condenser 300 and the compressor 200, parallel to the cooling branch 800 and to the air conditioning branch 804 comprising the internal evaporator 601. More precisely, the thermal treatment branch 850 extends between the fourth intersection 814 and the fifth intersection 815.

It should be noted that, in order to control a circulation of refrigerant fluid 700 in the thermal treatment branch 850, the latter is equipped with a flow rate control valve, called a fifth flow rate control valve 65, and with an expansion member, called a fourth expansion member 404. These two elements are located upstream of the additional heat exchanger 100. Preferably, the fifth flow rate control valve 65 is located upstream of the fourth expansion member 404.

The advantage of such a circuit 1003 compared to the preceding circuit 1002 is the reduction of the pressure drops on the low-pressure branch 810, 818 located directly upstream of the compressor 200.

A fourth example of a circuit 1004, illustrated in FIG. 5, shows that the thermal treatment branch 850 dedicated to cooling the traction battery 3 comprises a bypass forming the cooling branch 800 dedicated to cooling the electrical connection device 10. In other words, the cooling branch 800 is a bypass for the branch 850 including the additional heat exchanger 100. The heat exchanger 900 dedicated to cooling the electrical connection device is, in this case, parallel to the heat exchanger 100 dedicated to the thermal treatment of the traction battery 3.

To control the circulation of refrigerant fluid in the cooling branch 800 dedicated to cooling the electrical connection device 10, which cooling branch is mounted as a bypass, the latter is equipped with a flow rate control valve, called a sixth flow rate control valve 66. Advantageously, the bypass is located downstream of an expansion member, called a fifth expansion member 405, which is located on the thermal treatment branch 850. Of course, the bypass could be located upstream of the fifth expansion member 405. In this case, the cooling branch 800 for the electrical connection device 10 would comprise a separate expansion member thereof located, for example, downstream of the sixth flow rate control valve 66.

The main advantage of this fourth example of a circuit 1004 is the possibility of being able to connect the cooling branch 800 dedicated to cooling the electrical connection device 10 on an already existing refrigerant fluid 700 and traction battery 3 cooling circuit. Thus, this makes it possible to also be able to simply separate the cooling of electrical elements, such as the traction battery 3 and the connection device 10, from the cooling dedicated to the vehicle interior. To achieve this, a single valve 60 controls the circulation of the refrigerant fluid in the additional branch 850 and in the cooling branch 800 dedicated to the thermal treatment of the connection device 10.

Regardless of the example selected, and regardless of the connection of the cooling branch 800 dedicated to the connection device 10, the invention makes it possible to produce a heat exchange for improving the charging of the battery of a motor vehicle 2. Through the use of a refrigerant fluid 700 circuit available on the vehicle in order to feed such a cooling branch 800, the invention allows easy incorporation into a motor vehicle in which there are stringent spatial requirement constraints. Moreover, by incorporating the cooling of the traction battery itself, this circuit helps to improve the life of this battery.

The invention cannot, however, be limited to the means and configurations described and illustrated, and it is also used for any means, or any configurations, that are the same and for any combinations of such means and/or configurations. Indeed, if the invention has been described and illustrated in this case according to various alternative embodiments each separately using a specific arrangement, it goes without saying that these shown arrangements can be combined without this being detrimental to the invention.

1. A vehicle refrigerant fluid circuit comprising:
a compressor configured to raise the pressure of the refrigerant fluid;
a condenser, located downstream of the compressor according to a circulating direction of the refrigerant fluid in the circuit;
an expansion member, located downstream of the condenser, for lowering the pressure of the refrigerant fluid;
an evaporator, located downstream of the expansion member; and
a heat exchanger dedicated to cooling a charge port located on the vehicle and/or the interconnect located on the vehicle linking an electrical source and the battery to be charged.

2. The circuit according to claim 1, wherein the heat exchanger dedicated to cooling a charge port located on the vehicle and/or the interconnect located on the vehicle linking an electrical source and the battery to be charged is configured to produce a heat exchange between the refrigerant fluid and the charge port located on the vehicle and/or the interconnect located on the vehicle linking an electrical source and the battery to be charged.

3. The circuit according to claim 1, further comprising a cooling branch which includes the heat exchanger dedicated to cooling a charge port located on the vehicle and/or the interconnect located on the vehicle linking an electrical source and the battery to be charged, said cooling branch extending into a low-pressure segment connected to the condenser and to the compressor.

4. The circuit according to claim 3, wherein the cooling branch comprises a flow rate control valve located between the condenser and the heat exchanger dedicated to cooling a charge port located on the vehicle and/or the interconnect located on the vehicle linking an electrical source and the battery to be charged.

5. The circuit according to claim 3, wherein the cooling branch extends parallel to a so-called air conditioning branch comprising the evaporator.

6. The circuit according to claim 1, wherein the cooling branch comprises an expansion member, called a second expansion member, located between the condenser and the heat exchanger dedicated to cooling a charge port located on the vehicle and/or the interconnect located on the vehicle linking an electrical source and the battery to be charged.

7. The circuit according to claim 3, further comprising a second heat exchanger to cool a traction battery of the vehicle.

8. The circuit according to claim 7, further comprising a thermal treatment branch including the second heat exchanger, said thermal treatment branch being placed parallel to the cooling branch.

9. The circuit according to claim 7, further comprising a thermal treatment branch including the second heat exchanger, the cooling branch forming a bypass for said thermal treatment branch.

10. The circuit according to claim 7, wherein the heat exchanger dedicated to cooling the connection device is placed in series with the second heat exchanger on the cooling branch.
